(19) United States
(12) Patent Application Publication
(10) Pub. No.: US 2020/0150498 A1
(43) Pub. Date: May 14, 2020

(54) DISPLAY, CONTROLLER, AND ELECTRONIC DEVICE

(71) Applicant: SHARP KABUSHIKI KAISHA, Sakai City (JP)

(72) Inventor: MASAFUMI ITO, Sakai City (JP)

(21) Appl. No.: 16/682,772

(22) Filed: Nov. 13, 2019

(30) Foreign Application Priority Data
Nov. 14, 2018 (JP) 2018-213817

(51) Int. Cl. G02F 1/1362; G06F 3/0488

(52) U.S. Cl. CPC G02F 1/136209; G06F 2203/04105; G02F 2201/46; G06F 3/0488

(57) ABSTRACT

A display panel that displays an image and a cover panel that is superposed onto a front surface of the display panel and protects the display panel are included. An opening is formed in at least part of the cover panel, a device by which input or output of predetermined information is performed is provided in the opening, and black display is performed in an area of the display panel, which faces the device.

### BACKGROUND

### 1. Field

The present disclosure relates to a display or the like provided in an electronic device.

### 2. Description of the Related Art

In the related art, a known configuration of an electronic device includes a device different from the display on the same side where the display is provided. For example, Japanese Unexamined Patent Application Publication Mo. 2014-99709 (published on May 29, 2014) discloses a configuration in which a cover panel covering a display is stuck to a periphery of a front-side cabinet that houses the display and a button of a pressing type is arranged in an area of the cover panel outside a display area.

In the related art as described above, the button of the pressing type is to be arranged outside the display area, and there is thus a problem that the display area is reduced when it is difficult to increase an external size of an electronic device.

As a method for coping with such a problem, it is considered that a device such as the button of the pressing type is arranged in the area of the cover panel within the display area. Thereby, a size of the display panel is able to be decided without considering a position or a size of the device, and therefore the display panel with the size corresponding to an entire surface of the electronic device is able to be used for the electronic device, for example.

In a case where part or all of the device is arranged immediately above the display area of the display panel, however, another problem that stray light may leak from a gap between structures is caused depending on variation of components.

An aspect of the disclosure is made in view of the aforementioned problems and achieves a display or the like capable of reducing leakage of stray light from a gap between structures near an opening.

### SUMMARY

A display according to an aspect of the disclosure is a display including a display panel that displays an image, and includes a cover panel that is superposed onto a front surface of the display panel and protects the display panel, in which an opening is formed in at least part of the cover panel, a device by which input or output of predetermined information is performed is provided in the opening, and black display is performed in an area of the display panel, which faces the device.

An electronic device according to an aspect of the disclosure is an electronic device including at least one display and at least one controller, in which the at least one display includes: a display panel that displays an image; and a cover panel that is superposed onto a front surface of the display panel and protects the display panel, an opening is formed in at least part of the cover panel, a device by which input or output of predetermined information is performed is provided in the opening, black display is performed in an area of the display panel, which faces the device, and the at least one controller performs control to display the image on the display panel and performs input or output of the predetermined information from the device.

### Advantageous Effects of Invention

An aspect of the disclosure advantageously provides a display that reduces leakage of stray light from a gap between structures near an opening.

### BRIEF DESCRIPTION OF THE DRAWINGS

FIG. 1 is a block diagram illustrating an example of a configuration of a principal part of an electronic device according to an embodiment of the disclosure;

FIG. 2 is a schematic view illustrating an outline of a positional relationship of a display panel, a cover panel, and an opening in the electronic device;

FIG. 3A is a sectional view around a device and illustrates an example of physical arrangement of various members in the electronic device;

FIG. 3B is an enlarged view of area IIIB indicated by a broken line in FIG. 3A (sectional view illustrating a configuration of a display according to an embodiment of the disclosure); and

FIG. 4 is a sectional view illustrating a configuration of a display of a modified example.

### DESCRIPTION OF THE EMBODIMENTS

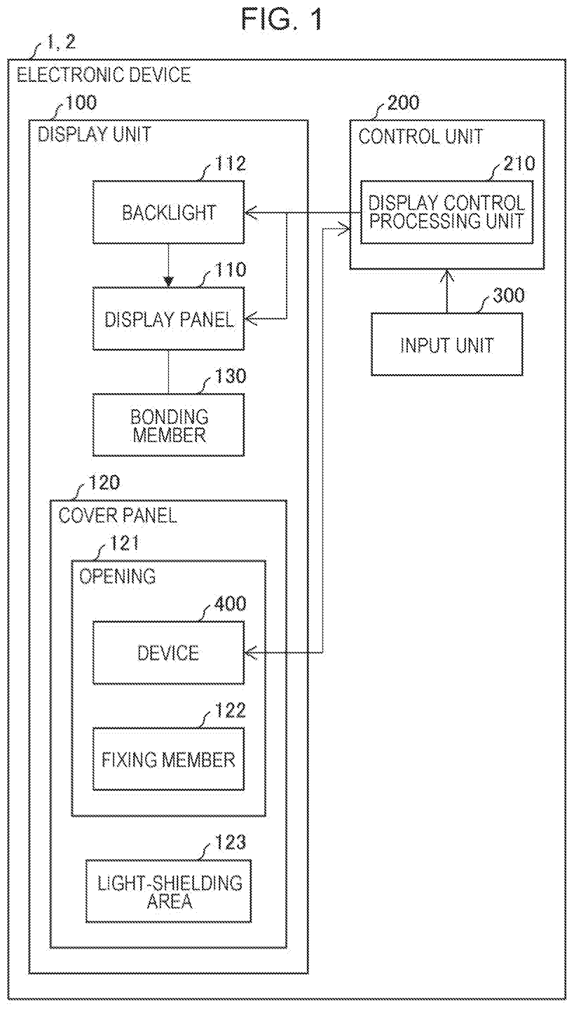

An embodiment of the disclosure will be described below in detail with reference to FIGS. 1 to 4.

### (Outline of Electronic Device)

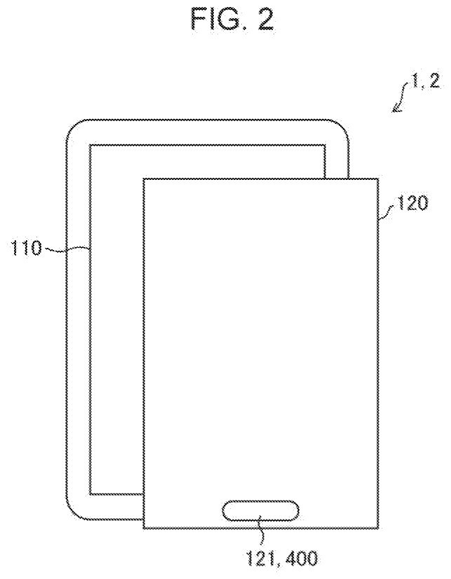

An outline of an electronic device 1 according to the present embodiment will be described with reference to FIG. 2. FIG. 2 is a schematic view illustrating an outline of a positional relationship of a display panel 110, a cover panel 120, and an opening 121 in the electronic device 1 (or electronic device 2 of a modified example described below).

The electronic device 1 is, for example, a smartphone including the display panel 110 that displays an image. The electronic device 1 includes the cover panel 120 that is superposed onto a front surface of the display panel 110 and protects the display panel 110. That is, an entire surface of the display panel 110 is protected by the cover panel 120. Note that, in the present embodiment, description will be given by assuming that the display panel 110 is a liquid crystal panel, but the display panel 110 is not limited to the liquid crystal panel.

The opening 121 is formed in at least part of the cover panel 120. A device 400 that performs input or output of predetermined information usable in the electronic device 1 is fixed to the opening 121 by a fixing member that is not illustrated. The electronic device 1 is able to perform input or output of information by use of the device 400 provided in the opening 121 of the cover panel 120 in parallel with display of an image by the display panel 110, for example.

Since the device 400 is superposed onto the display panel 110, a size of the display panel 110 is able to be decided without considering a position or a size of the device 400. For example, the display panel 110 with the size corresponding to an entire surface of the electronic device 1 is able to be used for the electronic device 1. In this manner, the electronic device 1 according to the present embodiment enables a higher degree of design freedom to be achieved, for example, in arrangement of the display panel 110 than in a conventional configuration.

### (Configuration of Electronic Device)

A configuration of the electronic device 1 (or the electronic device 2 of the modified example described below) according to the present embodiment will be described with reference to FIG. 1. FIG. 1 is a block diagram illustrating an example of a configuration of a principal part of the electronic device 1. The electronic device 1 includes a display unit 100, a control unit 200, and an input unit 300, and the display unit 100 includes the display panel 110, a backlight 112, the cover panel 120, and a bonding member 130.

The opening 121 is provided in the cover panel 120, and a fixing member 122 and the device 400 are provided in the opening 121. The control unit 200 includes a display control processing unit 210.

The electronic device 1 is, for example, a smartphone including at least one display unit 100 and at least one control unit 200. The electronic device 1 may be a tablet terminal, a notebook personal computer, or the like.

The display unit 100 is, for example, a liquid crystal display that functions as a display included in the electronic device 1. The display unit 100 may have any configuration as long as an image is able to be displayed and may be, for example, an organic EL display.

The display panel 110 and the backlight 112 are able to display the image under control of the display control processing unit 210. The display panel 110 may have a known configuration as long as an image is able to be displayed, and examples thereof include a liquid crystal panel and an organic EL panel. The backlight 112 is provided in a case where the display panel 110 is a device, such as a liquid crystal panel, which is not constituted by a self-light-emitting element, and the backlight 112 irradiates the display panel 110 with light.

The cover panel 120 is superposed onto the front surface of the display panel 110 and is able to protect the display panel 110. The cover panel 120 is desired to be formed of a transparent material such as glass or plastic so that the image displayed on the display panel 110 is seen. The cover panel 120 is fixed to the front surface of the display panel 110 by the bonding member 130, and the opening 121 is formed in at least part of the cover panel 120.

In the cover panel 120, a light-shielding area 123 for blocking light described below is provided around the opening 121. Details of the light-shielding area 123 will be described later.

The bonding member 130 enables the display panel 110 and the cover panel 120 to be bonded. The bonding member 130 is a transparent member that has a certain thickness and adhesiveness, and examples thereof include optical clear adhesive (OCA) tape that is used for bonding a display panel in a smartphone, a tablet terminal, or the like.

The opening 121 is an opening formed in at least part of the cover panel 120 and the device 400 is fixed to the opening by the fixing member 122. Though a position and a size of the opening 121 are not restrictive, the opening 121 and the device 400 are desired to be provided near an end of the cover panel 120 so that images are able to be displayed on the display panel 110 without making a user feel uncomfortable.

The fixing member 122 is an opaque member that fixes the device 400 to the opening 121. The fixing member 122 may fix the device 400 in any manner and may fix the device 400 by glue (not illustrated) or by screwing or welding.

The fixing member 122 is disposed in a gap between the device 400 and the opening 121. When the opaque fixing member is disposed in the gap, a boundary between the image displayed on the display panel 110 and the opening 121 is able to be clearly shown.

The light-shielding area 123 described later is an area provided in at least part of the cover panel 120 and enables an area of the display panel 110, which faces the light-shielding area 123, to be a non-display area. The light-shielding area 123 may be provided, for example, as black print on the cover panel 120. The light-shielding area 123 is desired to be provided so as to shield, against light, an area where the bonding member 130 is not applied in the cover panel 120 and is able to reduce leakage of light within a housing of the electronic device 1 from a gap to outside (generation of stray light).

The device 400 is a member that is provided in the opening 121 of the cover panel 120 by the fixing member 122 and enables input or output of predetermined information. The device 400 may be, for example, a fingerprint sensor that detects a fingerprint of a user, the predetermined information may be data information about the fingerprint detected by the fingerprint sensor, and the data information is transmitted or received to or from the control unit 200.

According to the aforementioned configuration, the display panel 110 and the fingerprint sensor are able to be arranged on the same surface in the electronic device 1. As a result, for example, unlike an electronic device in which the fingerprint sensor is arranged on a surface opposite to the display panel 110, the electronic device 1 is able to perform display of an image and detection of a fingerprint at the same time in a state where the electronic device 1 is placed on a desk.

The control unit 200 functions as a controller that integrally controls each unit of the electronic device 1. The control unit 200 is able to generate an instruction according to a user operation received by the input unit 300 and control each unit based on the instruction. The control unit 200 is able to transmit or receive information to or from the device 400 and causes the device 400 to input or output the predetermined information.

The display control processing unit 210 is able to control the display panel 110 and the backlight 112 in accordance with the instruction from the control unit 200. The display panel 110 is controlled by the display control processing unit 210 so as to display an image.

The backlight 112 is controlled by the display control processing unit 210 as to luminance or the like of display on the display panel 110. The display control processing unit 210 may control the display unit 100 so that an image is not displayed in an area, which overlaps the opening 121, of the display panel 110.

Upon reception of a user operation, the input unit 300 functions as an input device that transmits a signal according to the received user operation to the control unit 200. The input unit 300 may be, for example, a touch panel made of a transparent member and integrally formed with the display panel 110 or may be a physical button or the like.

### (Specific Example of Arrangement of Members)

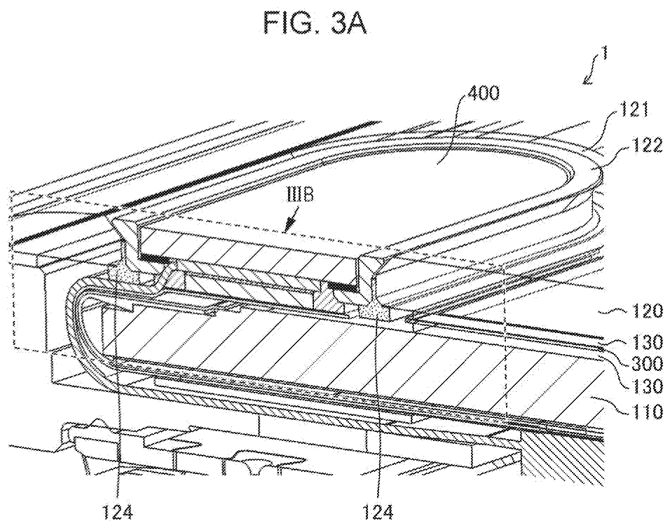

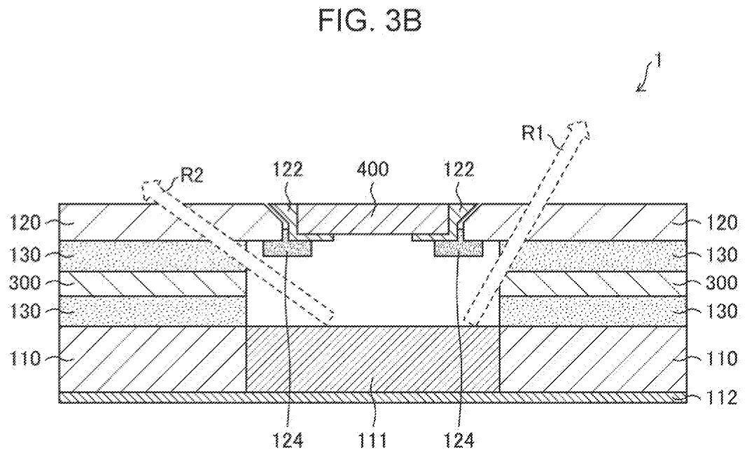

A specific example of physical arrangement around the device 400 in the electronic device 1 according to the present embodiment will be described with reference to FIGS. 3A and 33. FIG. 3A is a sectional view around the device 400 and illustrates an example of physical arrangement of various members in the electronic device 1. FIG. 3B is an enlarged view of area IIIB indicated by a broken line in FIG. 3A. Mote that, in the following description, it is assumed that a surface of the cover panel 120 in contact with an outside is a front surface and a surface of the cover panel 120 facing the boding member 130 and the display panel 110 is a back surface.

Arrangement of members around the device 400 will be described with reference to FIG. 3A. The electronic device 1 includes the cover panel. 120 having the opening 121 and having a predetermined thickness. The fixing member 122 having a thickness substantially equal to that of the cover panel 120 is embedded in the opening 121, and further, the device 400 is embedded on the fixing member 122. It is desirable that heights of the cover panel 120, the fixing member 122, and the device 400 are adjusted so as to be substantially flush, but the thickness of the device 400 and its depth of embedding may be adjusted so that the height of the device 400 is lower than others, for example, in order to reduce occurrence of an erroneous operation.

The device 400 and the fixing member 122 are joined by glue different from the bonding member 130, and the fixing member 122 and the cover panel 120 are joined by glue different from the bonding member 130. The glue, unlike the bonding member 130, is not desired to transmit light related to an image displayed on the display panel 110 and thus may be made of an opaque material as long as the glue firmly joins members.

Arrangement of the display panel 110, the cover panel 120, and the device 400 will be described in detail with reference to FIG. 3B. As illustrated in FIG. 3B, the fixing member 122 is disposed in the opening 121 of the cover panel 120 and the device 400 is embedded on the fixing member 122.

An area (area immediately below the device 400) of the display panel 110, which faces the device 400, is a black display portion 111 where black display is performed. Thus, generation of stray light from the area (black display portion 111) of the display panel 110, which faces the device 400, is reduced. Accordingly, stray light conventionally generated from the area of the display panel 110, which faces the device 400, does not reach a gap between structures near the opening 121, and leakage of stray light from the gap between the structures near the opening 121 is thus able to be reduced. Note that, R1 and R2 indicate paths through which stray light passes when black display is not performed in the black display portion 111.

Moreover, in a case where the display panel 110 is an organic EL panel, by switching off pixels in the black display portion 111 of the display panel 110, black display is able to be performed in the black display portion 111 of the display panel 110.

Note that, the area of the black display portion 111 described above is appropriately decided in accordance with the component sizes and arrangement of the device 400, the opening 121, the fixing member 122, and the like, so that no stray light is seen.

Moreover, in the present embodiment, the device 400 is fixed to the opening 121 by the opaque fixing member 122, and the fixing member 122 is disposed in the gap between the device 400 and the opening 121. As a result, light is able to be blocked by the fixing member 122, and therefore leakage of stray light from the gap between the structures near the opening 121 is able to be further reduced.

Further, a recess is formed on a cover panel 120 side of the fixing member 122 and a bonding member 124 by which the cover panel 120 and the fixing member 122 are bonded is provided in the recess. When the bonding member 124 is made of an opaque bonding member, light is able to be blocked by the bonding member 124, and leakage of stray light from the gap between the structures near the opening 121 is able to be further reduced.

### Modified Example

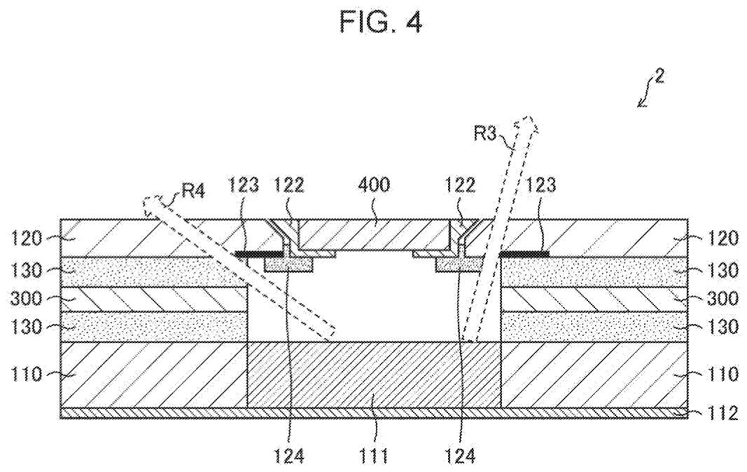

Next, a configuration of the electronic device 2 that is a modified example of the electronic device 1 will be described with reference to FIG. 4. The electronic device 2 of the modified example is different from the electronic device 1 in that the light-shielding area 123 for blocking light is formed on a surface of the cover panel 120, on the periphery of the opening 121, facing the display panel 110. Note that, R3 and R4 are paths through which stray light passes when black display is not performed in the black display portion 111.

That is, the light-shielding area 123 is provided in at least, part of the cover panel 120. For example, the light-shielding area 123 is formed on the surface of the cover panel 120, on the periphery of the opening 121, facing the display panel 110. That is, the light-shielding area 123 is formed on the back surface side of the cover panel 120 on the periphery of the fixing member 122 embedded in the opening 121.

As described above, the light-shielding area 123 is an area provided in at least part of the cover panel 120 and enables non-display of the area of the display panel 110, which faces the light-shielding area 123. The light-shielding area 123 may be provided as black print in the cover panel 120, for example.

As a result, since light is able to be blocked by the light-shielding area 123 formed on the surface of the cover panel 120, leakage of stray light from the gap between the structures near the opening 121 is able to be further reduced.

### CONCLUSION

A display according to an aspect 1 of the disclosure is a display including a display panel that displays an image, and includes a cover panel that is superposed onto a front surface of the display panel and protects the display panel, in which an opening is formed in at least part of the cover panel and a device by which input or output of predetermined information is performed is provided in the opening, and black display is performed in an area of the display panel, which faces the device.

According to the aforementioned configuration, black display is performed in the area of the display panel, which faces the device. Thus, generation of stray light from the area of the display panel, which faces the device, is reduced. Accordingly, stray light conventionally generated from the area of the display panel, which faces the device, does not reach a gap between structures near the opening, and leakage of the stray light from the gap between the structures near the opening is able to be reduced.

In the display according to an aspect 2 of the disclosure, it is desirable that, in the aspect 1, the device is fixed to the opening by a fixing member that is opaque, and the fixing member is disposed in a gap between the device and the opening. According to the aforementioned configuration, since light is able to be blocked by the fixing member that is opaque, leakage of stray light from the gap between the structures near the opening is able to be further reduced.

In the display according to an aspect 3 of the disclosure, it is desirable that, in the aspect 1 or 2 a light-shielding area that blocks light is formed on a surface, of the cover panel on a periphery of the opening, facing the display panel. According to the aforementioned configuration, since light is able to be blocked by the light-shielding area formed on the surface of the cover panel, leakage of stray light from the gap between the structures near the opening is able to be further reduced.

In the display according to an aspect 4 of the disclosure, in any of the aspects 1 to 3, the device may be a fingerprint sensor that detects a fingerprint of a user. According to the aforementioned configuration, the display panel and the fingerprint sensor are able to be arranged on the same surface in the electronic device. As a result, for example, unlike an electronic device in which the fingerprint sensor is arranged on a surface opposite to the display panel, the display performs display of the image and detection of the fingerprint at the same time in a state where the electronic device is placed on a desk.

An electronic device according to an aspect 5 of the disclosure is an electronic device including at least one display and at least one controller, in which the at least one display includes a display panel that displays an image and a cover panel that is superposed onto a front surface of the display panel and protects the display panel, an opening is formed in at least part of the cover panel and a device by which input or output of predetermined information is performed is provided in the opening, black display is performed in an area of the display panel, which faces the device, and the at least one controller performs control to display the image on the display panel and performs input or output of the predetermined information from the device. According to the aforementioned configuration, operation and effect similar to that of the aspect 1 is exerted.

### APPENDIX

The disclosure is not limited to each of the embodiments described above, and may be modified in various manners within the scope indicated in the claims and an embodiment achieved by appropriately combining techniques disclosed in different embodiments is also encompassed in the technical scope of the disclosure. Further, by combining the techniques disclosed in each of the embodiments, a new technical feature may be formed.

The present disclosure contains subject matter related to that disclosed in Japanese Priority Patent Application JP 2018-213817 filed in the Japan Patent Office on Nov. 14, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display including a display panel that displays an image, the display comprising
a cover panel that is superposed onto a front surface of the display panel and protects the display panel, wherein
an opening is formed in at least part of the cover panel and a device by which input or output of predetermined information is performed is provided in the opening, and
black display is performed in an area of the display panel, which faces the device.

2. The display according to claim 1, wherein
the device is fixed to the opening by a fixing member that is opaque, and
the fixing member is disposed in a gap between the device and the opening.

3. The display according to claim 1, wherein
a light-shielding area that blocks light is formed on a surface of the cover panel, on a periphery of the opening, facing the display panel.

4. The display according to claim 1, wherein
the device is a fingerprint sensor that detects a fingerprint of a user.

5. An electronic device comprising at least one display and at least one controller, wherein
the at least one display comprises
a display panel that displays an image and
a cover panel that is superposed onto a front surface of the display panel and protects the display panel,
an opening is formed in at least part of the cover panel and a device by which input or output of predetermined information is performed is provided in the opening,
black display is performed in an area of the display panel, which faces the device, and
the at least one controller
performs control to display the image on the display panel and performs input or output of the predetermined information from the device.
